(19) United States
(12) Patent Application Publication
(10) Pub. No.: US 2023/0092221 A1
(43) Pub. Date: Mar. 23, 2023

(54) FOLDED WAVE WINDING WITH COVER

(71) Applicant: Schaeffler Technologies AG & Co. KG, Herzogenaurach (DE)

(72) Inventors: Alexander Lepold, Freudenstadt (DE); Dennis Kuhl, Bühl (DE); Christian Morgen, Haueneberstein (DE)

(73) Assignee: Schaeffler Technologies AG & Co. KG, Herzogenaurach (DE)

(21) Appl. No.: 17/908,954

(22) PCT Filed: Feb. 25, 2021
(86) PCT No.: PCT/DE2021/100184

§ 371 Date: Sep. 2, 2022

(30) Foreign Application Priority Data
Mar. 3, 2020 (DE) 10 2020 105 606.0

(51) Int. Cl. H02K 3/28; H02K 15/04

(52) U.S. Cl. CPC H02K 3/28; H02K 15/0478

(57) ABSTRACT

A winding mat arrangment which is provided as a stator winding for a stator, has at least two winding mats which cross one another. A method for producing a stator is also provided.

### CROSS-REFERENCE TO RELATED APPLICATIONS

This application is the U.S. National Phase of PCT Appin. No. PCT/DE2021/100184 filed Feb. 25, 2021, which claims priority to DE 10 2020 105 606.0 filed Mar. 3, 2020, the entire disclosures of which are incorporated by reference herein.

### TECHNICAL FIELD

The disclosure relates to a winding mat arrangement provided as a stator winding provided for a stator and to a method for producing a stator.

### BACKGROUND

Methods for producing a stator winding for a stator of an electrical machine, in particular for a motor vehicle, are already known from the prior art.

U.S. Pat. No. 8,966,742 B2 discloses a method for producing a stator winding for a stator of an electrical machine, in particular for a motor vehicle, wherein at least one phase of the stator winding is positioned in one level and wherein areas of the phase are bent towards one another along at least one fold line, so that a loop winding results.

US 2019/0260249 A1 discloses a coil for a rotating electrical machine, wherein the coil is mounted in a plurality of slots of a stator core, and wherein the slots extend in the circumferential direction. An overlapped shaft winding coil composed of a coil wire having a plurality of slot receiving portions accommodated in the slots and a plurality of coil end portions connecting in a chevron shape the slot receiving portions side by side outside the slots in an axial direction of the stator core forms the coil. At least two layers of coil wire are connected by a continuous wire-based connecting section, folded back and stacked in the connecting section.

However, the prior art has the disadvantage that the production process is always laborious.

### SUMMARY

It is therefore the object of the disclosure to avoid or at least to mitigate the disadvantages of the prior art. In particular, the manufacturing process is to be changed.

This object is achieved according to the disclosure in a generic device in that a winding mat arrangement provided for a stator as a stator winding is provided. The winding mat arrangement can then be attached or mounted on the stator body; for example, a laminated stator core. The winding mat arrangement has at least two winding mats. The winding mats cross one another.

As a result, the production process can be parallelized by providing the winding mats, which are more time-consuming to produce than assembling the winding mats in a final step before they are applied to a stator body. In this case, the crossing can be understood such that a first part of one winding mat is above/below the other winding mat and a second part is below/above the other winding mat.

In particular, the at least two winding mats can be joined together. This can be a simple folding process to join the at least two winding mats together.

The at least two winding mats can represent an X-shape in a sectional level. In this case, the sectional level can be a longitudinal direction in relation to a winding direction for winding the winding mat arrangement onto the stator. This principle can also be used for more than two winding mats.

In addition, each of the at least two winding mats can have wire wave windings. The number of wire wave windings of each winding mat can be the same. A simple configuration of a wave winding mat arrangement for use for winding onto a stator body can thus be produced from multiple wave winding mats.

Furthermore, connections of the at least two winding mats can be arranged next to one another. When the wave winding mat arrangement lies on a shelf, the connections of the respective wave winding mats can be arranged at a distance from one another/above one another. In this case, the connections can form a matrix that enables the use of a phase assignment diagram.

The object defined above is achieved according to the disclosure in a generic method in that a method for producing a stator is provided. The method comprises providing various winding mats. The method further comprises crossing the various winding mats into a winding mat arrangement. The method further comprises winding or introducing the winding mat arrangement onto or into a stator body, so that a stator is formed.

The production process can thus be improved.

Advantageous embodiments are claimed and are explained below.

The various winding mats can be joined to form the winding mat arrangement.

In addition, each of the different winding mats can have different opened levels. Here, the method can further comprise nesting the different winding mats. In addition, the method can further comprise folding over the levels relative to one another, so that essentially a common level of the winding mat arrangement is formed. When the individual mats are in the opened state, the various mats can be nested in such a way that an outer side associated with a level of one of the winding mats is connected to an inner side associated with a level of another of the winding mats. Likewise, the inner side belonging to the other level of one of the winding mats can be connected to or touch an outer side belonging to the other level of the other of the winding mats. After that, the levels can be aligned as a whole by folding them over.

The levels of the various winding mats can have different dimensions.

The various opened levels can be opened at an angle to each other before folding over. The wire meshes or wires contained in the levels or in the various winding mats can be folded in a serpentine or snake-like manner. In this case, the adjacent wires can be designed as a whole in a serpentine-like manner to the respective winding mat.

For example, in the folded state, at least a first strand section comes to lie parallel to a second strand section. A strand section can be understood as a section along the extension of the strand. The definition of such a strand section can be purely virtual, i.e., it is not tied to specific physical characteristics or even to an interruption in the strand. Frequently, however, the beginning or the end of a strand section will be associated with the course of the strand undergoing a change of direction within the level, for example making a kink.

In an unfolded state, the strand sections can form steps of a stepped overall structure.

Multiple strands can be used to make the stator winding. These can mostly be performed in parallel. To do this, several strands can simply be produced and stored in a magazine before the winding is folded. As soon as the required number of strands in the magazine has been reached, the strand is then folded into the winding mat.

The strands are preferably positioned as a distributed winding. By winding in opposite directions, the crossings of individual strands are spatially equalized, making it easier to deal with the crossings.

For example, a continuous wire can be used for the strand. This can apply to all strands. However, the strand can also be formed from multiple elements which are then electrically connected to one another.

A rectangular wire is advantageously used for the strand. Other conductor shapes are also conceivable.

A diameter of the conductor forming the strand can essentially correspond to or be smaller than a slot width of the slots in the stator core.

A further aspect herein can be an electrical machine, in particular for a motor vehicle, which has a stator winding, in particular the winding mat arrangement as described above, of the electrical machine. This can be an at least two-layer loop winding.

In other words, the disclosure relates to a folded wave winding with folding over. In particular, the disclosure relates to manufacturing a stator as an unrolled toothed chain and joining the distributed winding into the flat toothed chain. In particular, this is an adaptation of a distributed winding topology, in which the resulting mat is as compact as possible and can be joined in a toothed chain. Here, the winding mat should be able to be joined as far as possible into a toothed chain (unrolled stator).

With a wave winding, the challenge is to connect parallel winding branches in the end winding in such a way that no circulating currents can occur, despite the continuous winding scheme. Parallel winding branches per phase are necessary because, especially with a wave winding, a smaller conductor height (compared to so-called hairpin windings) is used and thus the number of conductors in the slot is increased. So that the resulting voltage per phase remains the same, the number of parallel winding branches must be increased.

With a conventional winding variant, the conductors can be wound continuously in a circle with an optional layer offset. This is not possible with a winding that is to be joined in a flat inverted tooth chain. Therefore, the winding direction has to be reversed and reversal points arise. Due to geometric boundary conditions, only every second level is occupied by a conductor at these reversal points. These reversal points are then plugged into one another when the winding is rolled up. The manufacturing process of such a wave winding is very complex.

In summary: The following problems are to be solved with the novel type of winding: Optimum interconnection of parallel winding branches to minimize the circulating currents and implement a flat/compact winding with reversal points, as well as simplifying the production concept.

According to one embodiment, the mats are produced in a first step, which are then plugged into one another in an X-shape for flat winding. The production of the mats can be done in the following way: Bending a flat preliminary scheme (separately for each phase), stacking the individual flat preliminary schemes, folding the stacked phase preliminary schemes to form a mat at bending lines and thereby creating the end winding.

At the level jump, the conductors are initially not bent to the final state in order to enable the mats to be plugged in in an x-shape. Only after the mats have been plugged in is the bending brought to its final state.

Even if some of the aspects described above were described in relation to the winding mat arrangement, these aspects can also apply to the stator and the electrical machine. Likewise, the aspects described above in relation to the stator or the electrical machine can apply in a corresponding manner to the winding mat arrangement.

If it means that a component is “connected” to another component, this can mean that it is directly connected to it or that it directly accesses it; however, it should be noted that another component can lie therebetween. On the other hand, when one component is “directly connected” to another component, it means that there are no other components therebetween.

### BRIEF DESCRIPTION OF THE DRAWINGS

The disclosure is explained below with the aid of drawings. In the figures:

FIG. 1 shows a schematic representation of a preliminary scheme;

FIG. 2 shows a schematic representation of a conductor arrangement in the preliminary scheme;

FIG. 3 shows a schematic representation of a stack of preliminary schemes;

FIG. 4 shows a schematic representation of a folding process;

FIG. 5 shows a schematic representation of a single mat prior to being folded over;

FIG. 6 shows a schematic representation of nested mats;

FIG. 7 shows a schematic representation of nested mats;

FIG. 8 shows a schematic representation of nested mats and a finished winding mat arrangement;

FIG. 9 shows a schematic representation of a winding mat arrangement;

FIG. 10 shows a schematic representation of a bent and inserted winding mat arrangement;

FIG. 11 shows a schematic representation of an assignment diagram; and

FIG. 12 shows a schematic representation of a winding arrangement.

### DETAILED DESCRIPTION

The figures are only schematic in nature and serve only for understanding the disclosure. The same elements are provided with the same reference signs. The features of the individual embodiments can be interchanged.

In addition, spatially relative terms such as “located below”, “under”, “lower”, “located above”, “upper”, “left”, “right”, and the like, may be used to simply describe the relationship of one element or structure to one or more other elements or structures depicted in the figures. The spatially relative terms are intended to encompass other orientations of the device in use or operation in addition to the orientation depicted in the figures. The component can be oriented differently (rotated 90 degrees or in a different orientation) and the spatially relative descriptors used herein interpreted accordingly as well.

The winding mat arrangement and the method for producing the stator will now be described with reference to embodiments.

To prevent circulating currents, a conductor along a winding path must see every slot in the slot block in every conductor level. The slot block means the superimposition of the individual poles per phase. Thus, it doesn't matter whether the conductor crosses level 1 in the first slot per pole in the first or in the second pole along the circumference. In the present case, a conductor changes one level up in each end winding. If the conductor has reached the top level, a level jump follows to the bottom level.

This shows the following level sequence (3,4,5,6,7,8,1,2) where z_n=8 conductor levels in the slot. In the area of the reversal points 8, 11, a conductor is exchanged for a different slot per pole, so that the rule mentioned above can be fulfilled. Due to the continuous level shifting, all conductors of each winding mat thus fulfill the rule.

Different numbers of parallel conductors a_mat are possible for the z_n/2 winding mats. The following condition must be met: mod(q/a_mat)=0 for connections at the same reversal point 8, 11 or mod(q/a_mat)=0.5 for connections at both reversal points. In the case of connections at the same reversal point 8, 11, the parallel winding arm connections are in zones next to one another.

The following explanations refer to a machine with a number of holes q=4, number of parallel conductors a=8, number of pole pairs p=4, z_n=8 and a number of slots N=96: Preliminary scheme for one phase (arrangement for a_mat=2 parallel conductors per winding mat).

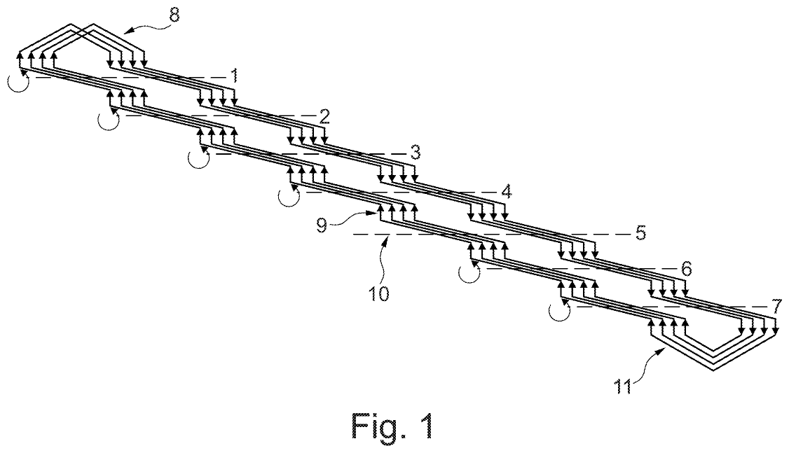

The embodiment requires four mats (z_n/2). The level jump 10 takes place here once on each odd bending line. The bending lines can be different for each mat. For example, for the first mat 7, the second mat 5, the third mat 3 and the fourth mat 1. The orientation of the bend can be seen from the arrows in FIG. 1. In the case of a level jump 10, the bending direction is outside of the scheme, for example folded only in half, at least not completely folded, so that the mats can later be interlocked. In the case of a level jump 10, a larger offset between the vertical slot pieces 9 is required due to the larger end winding length.

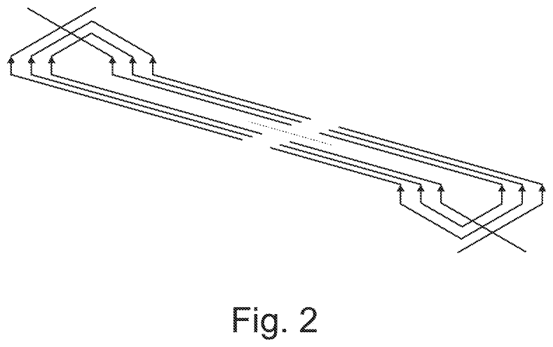

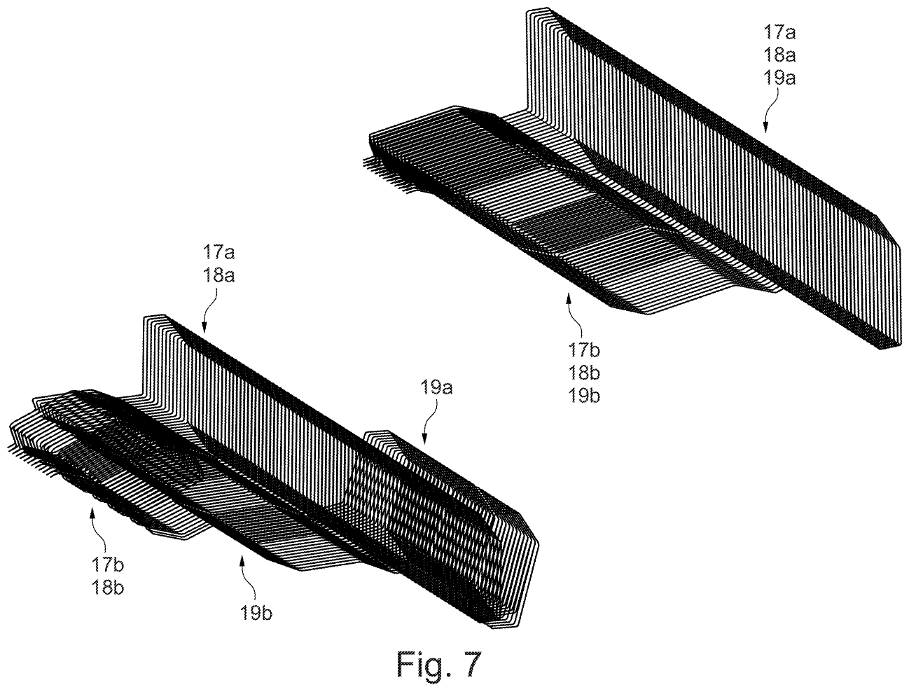

Further details and aspects are mentioned in connection with the embodiments described above or below. The embodiment shown in FIG. 1 may have one or more optional additional features corresponding to one or more aspects mentioned in connection with the proposed concept or embodiments described below in relation to FIGS. 2 to 12.

FIG. 2 shows a schematic conductor arrangement in a preliminary scheme 12, 13, 14 for a_mat=2 and q=3. Connections may be necessary at both reversal points. In general, conductors on the right and left loop sides lie in each slot level due to the folding. On each loop side, the conductors are always in the same slot for each pole. By interchanging the reversal points 8, 11, a conductor thus sees all the slots in each slot block. In the case of a trivial arrangement for a_mat=1, the arrangement of the conductors in the preliminary scheme follows a concentric loop.

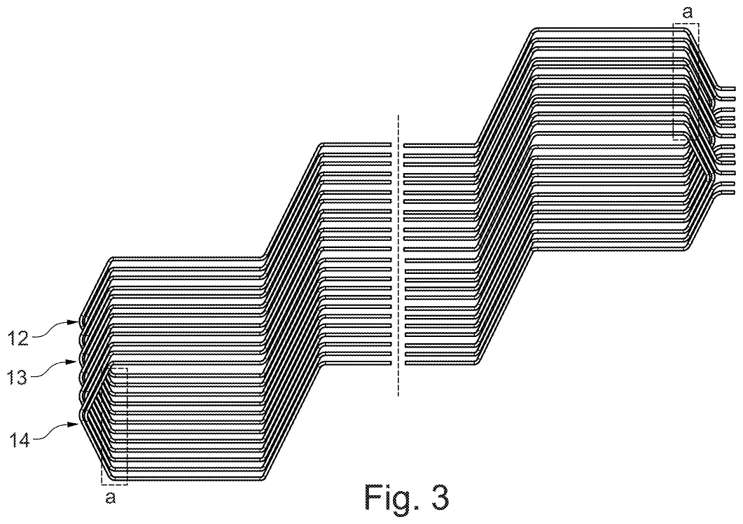

The stacking of the individual flat preliminary schemes 12, 13, 14 is shown in FIG. 3. A stacking of the individual preliminary schemes 12, 13, 14 is possible due to the shape of the end winding in the area of the reversal points 8, 11. The individual preliminary schemes 12, 13, 14 are layered in the same order at the reversal points 8, 11. Conductor bending can require an additional offset by the conductor height (in area a).

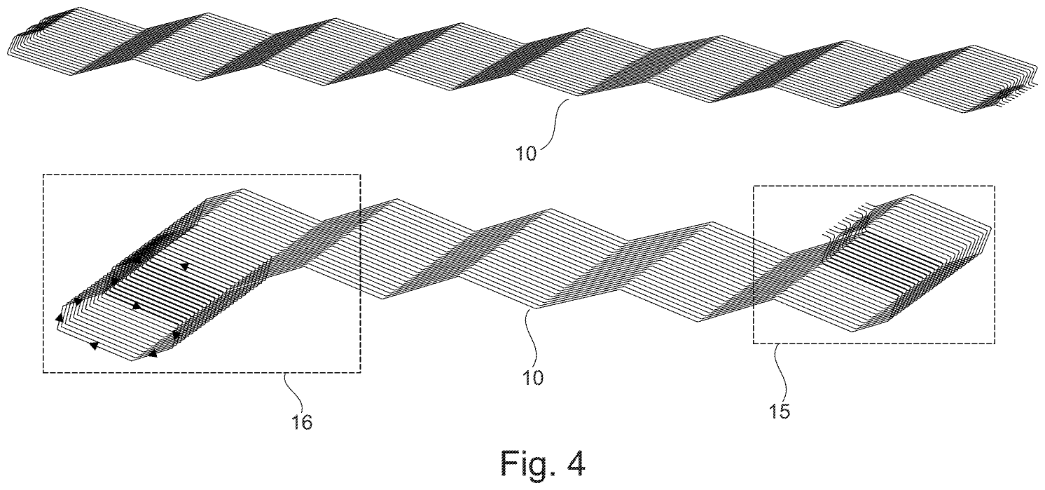

Further details and aspects are mentioned in connection with the embodiments described above or below. The embodiment shown in FIGS. 2, 3 may have one or more optional additional features corresponding to one or more aspects described in connection with the proposed concept or one or more embodiments described above (e.g., FIG. 1) or below (e.g., FIGS. 4 to 12).

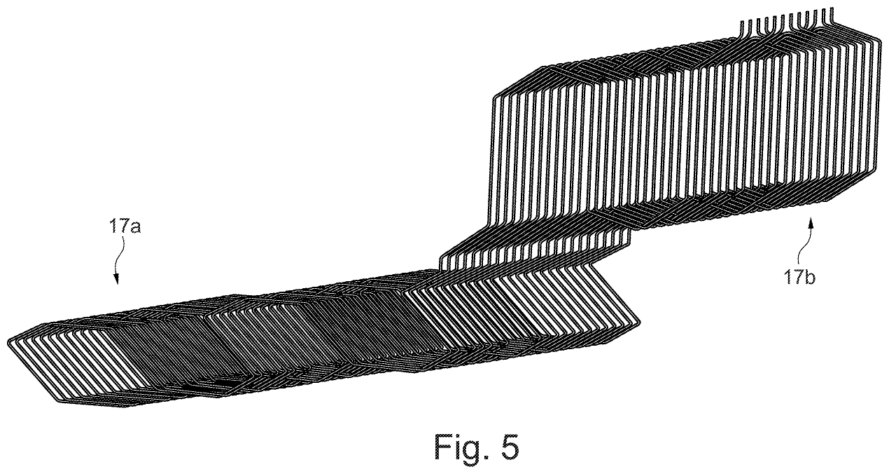

The folding process with a level jump 10 at the bending line 5 is shown as an example. A folding state during the folding process of the mat itself is shown schematically in FIG. 4, see folding sections 15, 16. In the area of the level jump 10, the bending takes place outside of the directional scheme (see FIG. 5); it does not initially follow the final state. The bending is shown here schematically at 90 degrees, but 0 degrees and 150 degrees are also conceivable in order to enable plugging in. The bending to the final state of 180 degrees only takes place after plugging in.

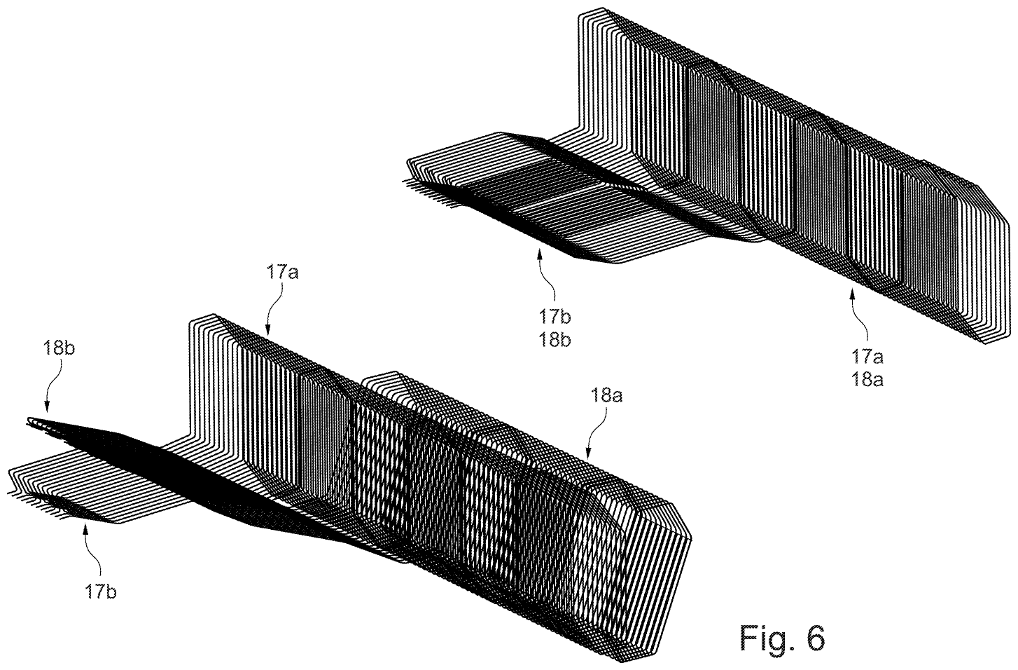

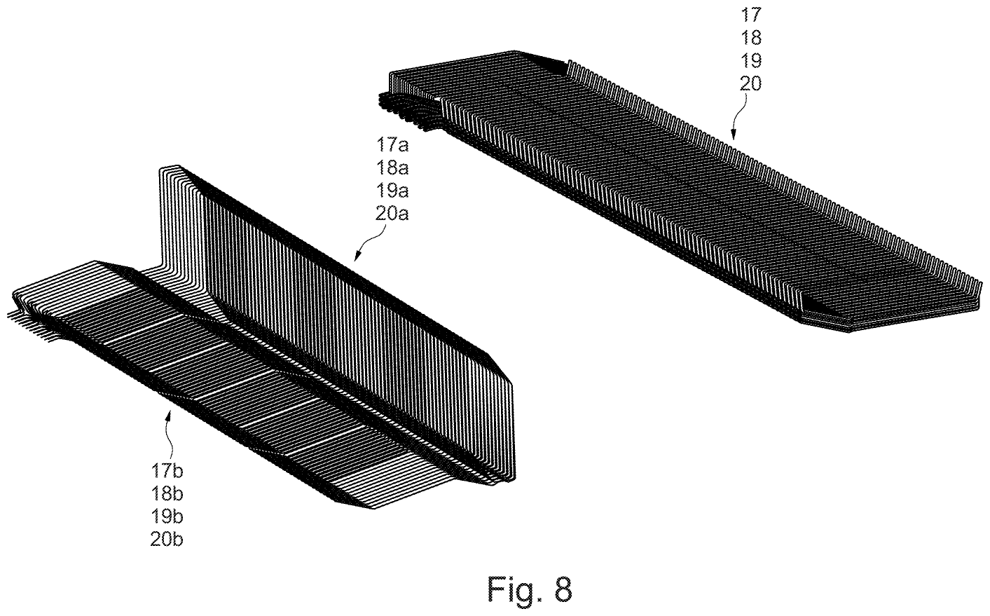

According to FIGS. 6 to 8, the mats 17, 18, 19, 20 are plugged or nested one inside the other in an X-shape. In this case, first partial areas 17a, 18a, 19a, 20a (also referred to as first levels) of the mats 17, 18, 19, 20 are arranged next to one another, at the top right in FIGS. 6 to 8. In this case, second partial areas 17b, 18b, 19b, 20b are also arranged next to one another, at the top in FIGS. 6 to 8. In an intermediate area between the first partial area 17a, 18a, 19a, 20a and the second partial area 17b, 18b, 19b, 20b, the mats 17, 18, 19, 20 are arranged next to one another, at the bottom according to FIGS. 6 to 8. When all mats 17, 18, 19, 20 are arranged relative to one another, the plugged in mats are then bent to the final state for the winding mat arrangement 21 (see FIG. 8, second illustration).

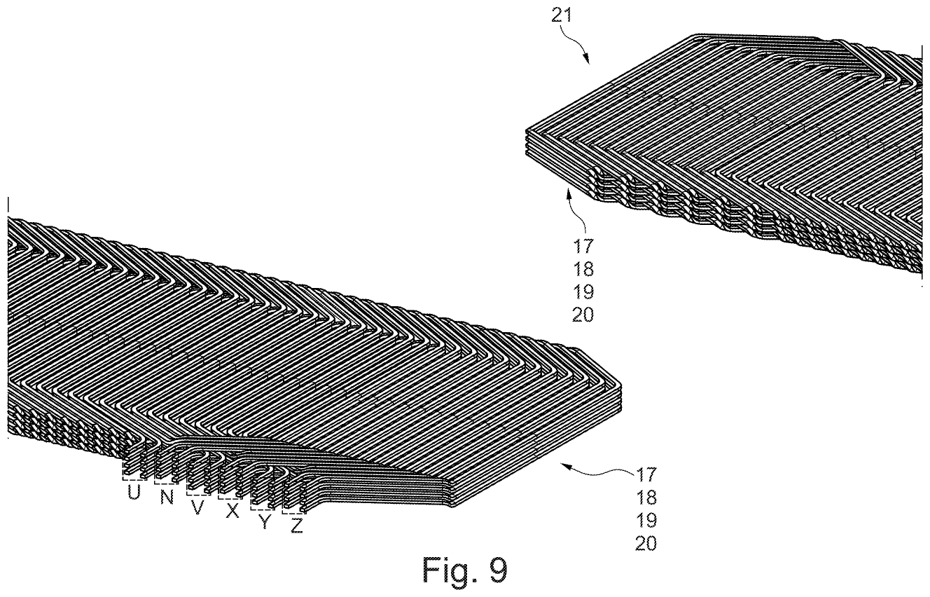

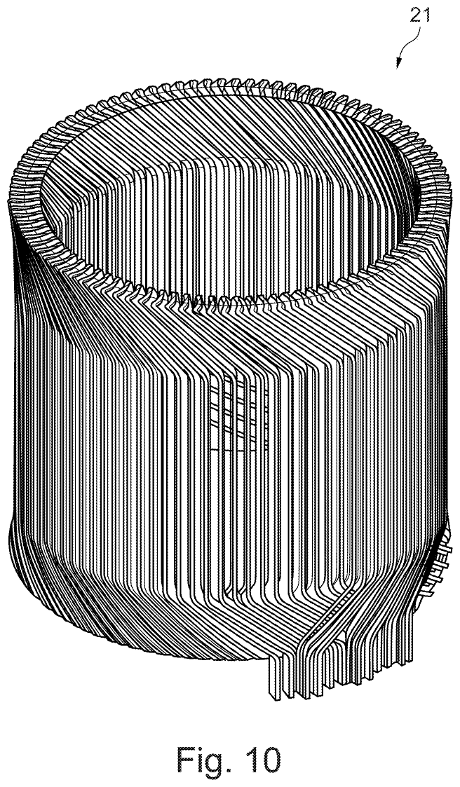

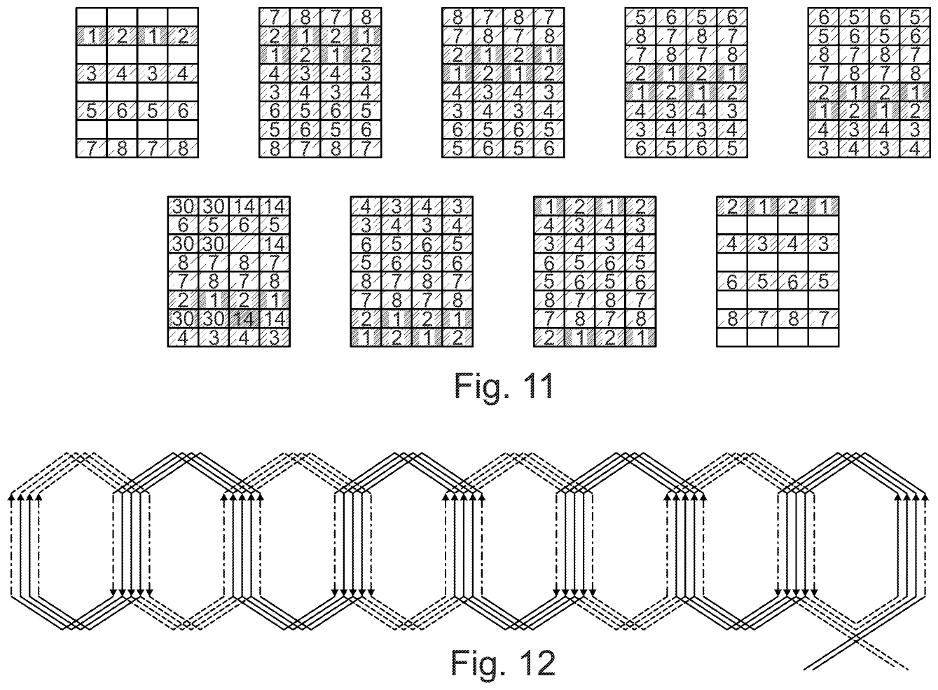

The reversal points of the finished mats 17, 18, 19, 20 and the connection zones U, V, W, X, Y, Z are shown in FIG. 9. A connection can preferably be provided as a star connection (X-Y-Z to star) or as a delta connection. In the reversal points 8, 11, only every second level is occupied by a conductor (see the assignment diagram for a phase in FIG. 11). In FIG. 10, the bent and plugged in winding, which is also referred to herein as the rolled up winding mat arrangement 21, is shown.

Further details and aspects are mentioned in connection with the embodiments described above or below. The embodiment shown in FIGS. 4 to 10 may have one or more optional additional features corresponding to one or more aspects described in connection with the proposed concept or one or more embodiments described above (e.g., FIGS. 1 to 3) or below (e.g., FIGS. 11 and 12).

FIG. 11 shows an assignment diagram for a phase as an example. If the winding step is shortened on one end and if the winding step Is lengthened on the opposite end, a chord is obtained (analogous to two-layer winding). In a multi-layer winding, the shifting of the winding layers is referred to as a chord. This shifting smooths the excitation curve and thus reduces the harmonics of the induced voltage. Due to the chord, the induced voltage amplitude decreases. The plug-in zone increases by the length of the shortening/lengthening. The production concept is not affected by this, except for the bending variation (see FIG. 12, dashed slot occupied once, solid slot occupied twice).

### LIST OF REFERENCE SYMBOLS

1-7 Bending points

8 Reversal point

9 Groove piece

10 Level jump

11 Reversal point

12 First preliminary scheme

13 Second preliminary scheme

14 Third preliminary scheme

15 Folding section

16 Folding section

17a First level—first mat

17b Second level—first mat

18a First level—second mat

18b Second level—second mat

19a First level—third mat

19b Second level—third mat

20a First level—fourth mat

20b Second level—fourth mat

17 First mat

18 Second mat

19 Third mat

20 Fourth mat

21 Winding mat arrangement

U Connection zones

N Connection zones

V Connection zones

1. A winding mat arrangment for a stator, comprising: at least two winding mats which cross one another.

2. The winding mat arrangement according to claim 1, wherein the at least two winding mats are joined together and represent an X-shape in a sectional level.

3. The winding mat arrangement according to claim 2, wherein the sectional level is a longitudinal direction in relation to a winding direction for winding mat arrangement onto the stator.

4. The winding mat arrangement according to claim 1, wherein each of the at least two winding mats has wire wave windings.

5. The winding mat arrangement according to claim 4, wherein a number of wire wave windings of each winding mat is the same.

6. The winding mat arrangements according to claim 1, wherein connections of the at least two winding mats are arranged next to one another and form a matrix which enables a phase assignment diagram

7. A method for producing a stator, the method comprising: providing a plurality of winding mats that are each different from one another; crossing the winding mats into a winding mat arrangement; and incorporating the winding mat arrangements into a stator body.

8. The method for producing a stator according to claim 7, wherein the winding mats are joined to form the winding mat arrangement, wherein each winding mat is produced by folding stacked phase preliminary schemes on bending lines.

9. The method for producing a stator according to claim 7, wherein each of the winding mats has different opened levels, and in that the method further comprises: nesting the winding mats and folding over the levels to one another, so that a common level of the winding mat arrangement is formed.

10. The method for producing a stator according to claim 9, wherein the levels of the winding mats have different dimensions.
